(19) United States
(12) Patent Application Publication
(10) Pub. No.: US 2006/0245433 A1
(43) Pub. Date: Nov. 2, 2006

(54) Apparatus and method for dynamic routing of messages with target validation and peer forwarding

(75) Inventors: Douglas Charles Berg, Rochester, MN (US); Pernell James Dykes, Byron, MN (US); William T. Newport, Rochester, MN (US); Hao Wang, Rochester, MN (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/117,619

(22) Filed: Apr. 28, 2005

(51) Int. Cl. H04L 12/56; H04L 12/54; H04L 12/28

(52) U.S. Cl. 370/395.31; 370/428

(57) ABSTRACT

One computer system in a cluster includes a dynamic routing mechanism that receives all incoming messages for the cluster. When a message is received, the dynamic routing mechanism checks its dynamic routing table, and routes a message to the appropriate partition that corresponds to the address of the message. If a resource has been moved to a different partition, the dynamic routing mechanism may route the message to the old partition instead of the new one. In this case, the old partition receives the message, determines whether the message is intended for it, and if not, the partition forwards the message to the appropriate target partition. The partition then notifies the dynamic routing mechanism of the change in location of the resource, which causes the dynamic routing mechanism to update its dynamic routing table to reflect the change in location for the resource.

### BACKGROUND OF THE INVENTION

1. Technical Field

This invention generally relates to computer systems, and more specifically relates to apparatus and methods for communicating between computer systems.

2. Background Art

Networked computer systems allow different computers to communicate with each other. The Internet is one example of a networked computer system that links millions of computers together. Of course, there are a large number of other types of computer networks as well. In clustered computer systems, multiple computer systems are coupled together in a way that allows the computer systems to share work. Clustered computer systems are becoming common as a way to provide high-reliability services (or resources). If a resource on one computer system goes down, that same resource may be made available on another computer system in the cluster. Note that a server may be partitioned into multiple partitions, thereby allowing a single server to include many different partitions that may receive messages from other computer systems.

In one specific example of a known clustered computer system, a routing mechanism includes a static routing table that is setup to indicate which addresses are assigned to which targets. When a message comes in to the routing mechanism, it checks the static routing table to determine whether there is an entry with the address of the message. If not, the message is ignored or an error message is returned. If there is an entry with the address of the message, the message is routed to the corresponding target specified in the entry.

One problem with the static routing table described above arises when a resource is moved between different targets within the cluster. There is currently no known way to automatically and immediately update the static routing table. As a result, a message that comes in after the resource is moved will be routed to the old target, not the new (correct) target. The message will not be able to be processed by the old target, so the message will be ignored or an error message will be returned. With sophisticated clustered computer systems that include a relatively large number of computer systems, the number and frequency of changes to the location of resources may be significant. Without a way to automatically handle a message that requests a resource that has moved to a new location, the computer industry will continue to suffer from errors resulting from routing a message to a target that can no longer process the message.

### DISCLOSURE OF INVENTION

A dynamic routing mechanism builds and replicates a dynamic routing table on each computer system in a cluster. One computer system in the cluster includes a dynamic routing mechanism that receives all incoming messages for the cluster. The dynamic routing mechanism includes a dynamic routing table that is built by querying the computer systems in the cluster. When a message is received, the dynamic routing mechanism checks the dynamic routing table, and routes a message to the appropriate partition that corresponds to the address of the message. If a resource has been moved to a different partition, the dynamic routing mechanism may have stale date in its dynamic routing table, and may route the message to the old partition instead of the new one. In this case, the old partition receives the message and performs validation on the message to determine whether the message is intended for it. If the message is not intended for that partition, the partition determines the appropriate target partition, and forwards the message to the appropriate target partition. The partition then notifies the dynamic routing mechanism that sent the message of the change in location of the resource, which causes the dynamic routing mechanism to update its dynamic routing table to reflect the change in location for the resource. In this manner, the routing table in each partition need not be kept completely synchronized, because any stale data will result in automatic validation and forwarding of the message to the correct partition, and will prompt automatic update of the stale data.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of a prior art clustered computer system;

FIG. 3 is a flow diagram of a prior art method for the prior art clustered computer system of FIG. 2;

FIG. 4 is a flow diagram of a prior art method showing an error message when a message is routed to the wrong partition;

FIG. 5 is a block diagram of a clustered computer system in accordance with the preferred embodiments;

FIG. 6 is a flow diagram of a method in accordance with the preferred embodiments for dynamically routing a message in the clustered computer system in FIG. 5;

FIG. 7 is a flow diagram of a method in accordance with the preferred embodiments for a target partition to validate a message and forward the message to the correct partition if the target partition should not process the message;

FIG. 8 is a block diagram of a clustered computer system that includes multiple partitions; and

FIG. 9 is a block diagram of the clustered computer system in FIG. 8 after Resource A has been moved from Partition 2 to Partition 5.

### BEST MODE FOR CARRYING OUT THE INVENTION

### 1.0 Overview

The present invention relates to the routing of messages in a clustered computer system. For those not familiar with message routing in a clustered computer system, this Overview section will provide background information that will help to understand the present invention.

### Known Clustered Computing Systems

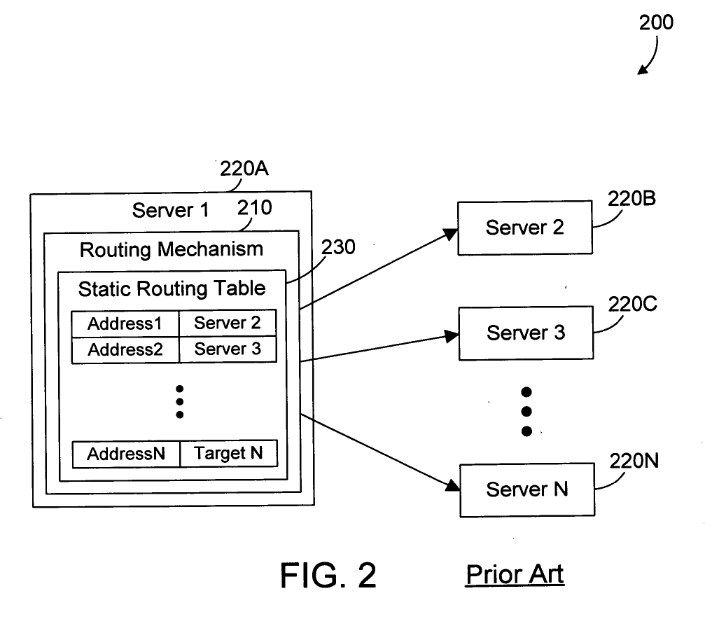

One known configuration for a clustered computing system is shown as computer system 200 in FIG. 2. Computer system 200 includes a routing mechanism 210 that is preferably in a first server computer system 220A. The routing mechanism 210 is a router that receives all messages for the cluster, and routes the messages to the appropriate targets (i.e., other servers in the partition). The first server 220A is coupled via a network connection to multiple other servers, shown in FIG. 2 as servers 220B, 220C, . . . , 220N. The routing mechanism 210 includes a static routing table 230 that includes a plurality of address/server tuples. A message received by the routing mechanism 210 will include an address. When the routing mechanism 210 receives a message, it looks at the address of the message, and determines from the static routing table 230 the server that corresponds to the address of the message. The routing mechanism 210 then routes the message to the corresponding server indicated in the static routing table 230.

One problem with system 200 in FIG. 2 is the inability to adapt to changes in servers when a resource is moved to a different location. The static routing table 230 is typically configured when the cluster first powers up. There is no known way to dynamically update the static routing table to accommodate changes in the location of resources. For example, let's assume that server 220B hosts a desired resource, and that server 220B encounters an error and shuts down. Known failover techniques may be used to move the desired resource to a different server, such as server 220C. Note, however, that the static routing table 230 still indicates that server 220B is the target server for a message for the desired resource. As a result, when a message for the desired resource is received by the routing mechanism 210, the routing mechanism 210 will attempt to route the message to server 220B, which no longer hosts the desired resource. This will result in a failure, even though the desired resource is alive and well on server 220C. As a result, the failover of the desired resource does little good because the relocation to a different server is not dynamically reflected in the static routing table 230.

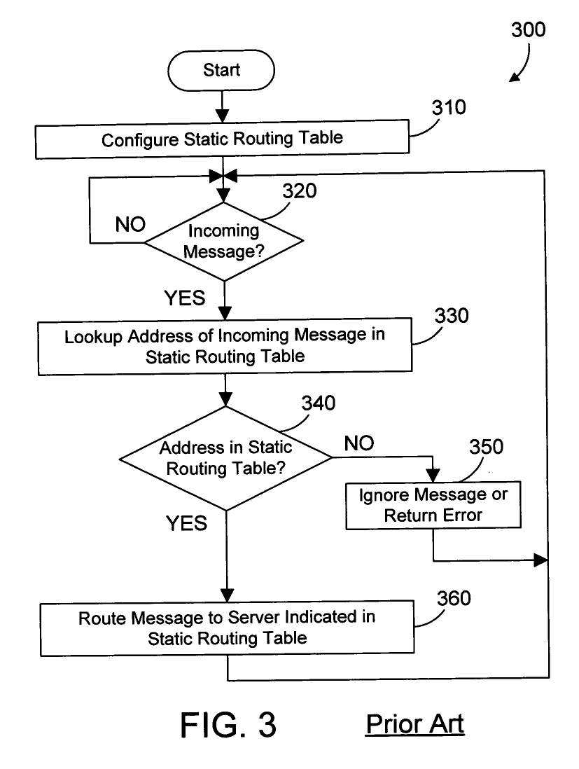

Referring to FIG. 3, a method 300 illustrates the prior art method for computer system 200 in FIG. 2. First, the static routing table is configured (step 310). Method 300 then waits for an incoming message (step 320=NO). Once a message is received (step 320=YES), the address of the message is looked up in the static routing table (step 330). If the address in the message is not in the static routing table (step 340=NO), the message is ignored or an error is returned (step 350). If the address in the message is in the static routing table (step 340=YES), the request is routed to the server indicated in the static routing table (step 360).

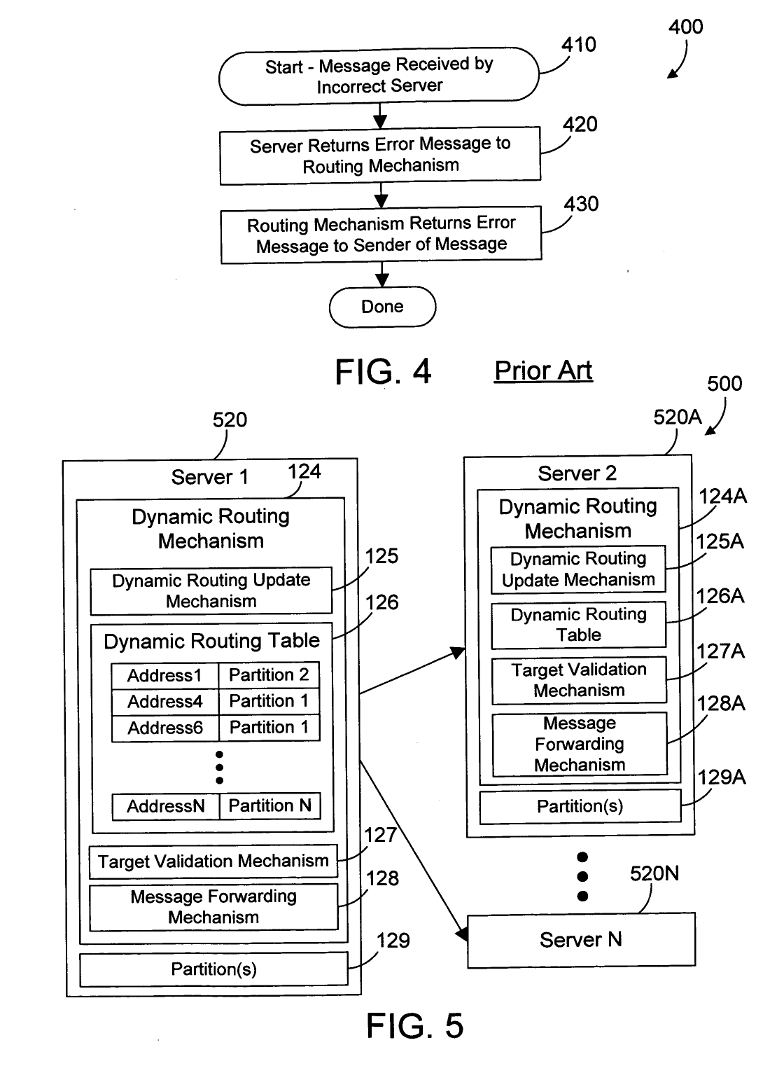

One of the problems in the known configuration in FIGS. 2 and 3 is shown by method 400 in FIG. 4. Method 400 starts when a message is received by an incorrect server (step 410). This can happen when a resource is moved to a different server and the dynamic routing table in the router has stale data that sill points to the old server. In this case, the server returns an error message to the routing mechanism (step 420). The routing mechanism then returns an error message to the sender of the message (step 430). Because the routing table 230 in FIG. 2 is configured statically in step 310 in FIG. 3, and because there is no known way to dynamically update the static routing table, moving a resource to a different partition results in an error. In modern clustered computer systems, there may be thousands of different partitions that host many different resources that need to change locations frequently to different servers. As a result, the error messages shown in FIG. 4 cause a significant reduction in performance.

### 2.0 Description of the Preferred Embodiments

The dynamic routing mechanism of the preferred embodiments overcomes these problems in known routing mechanisms by providing a dynamic routing mechanism that may include stale data, but by providing additional mechanisms that account for a potential routing of a message to the wrong partition. When this occurs, the receiving partition validates the message, determines the message is for a different partition, forwards the message to the different partition, and tells the dynamic routing mechanism that its dynamic routing table needs to be updated to replace the stale data.

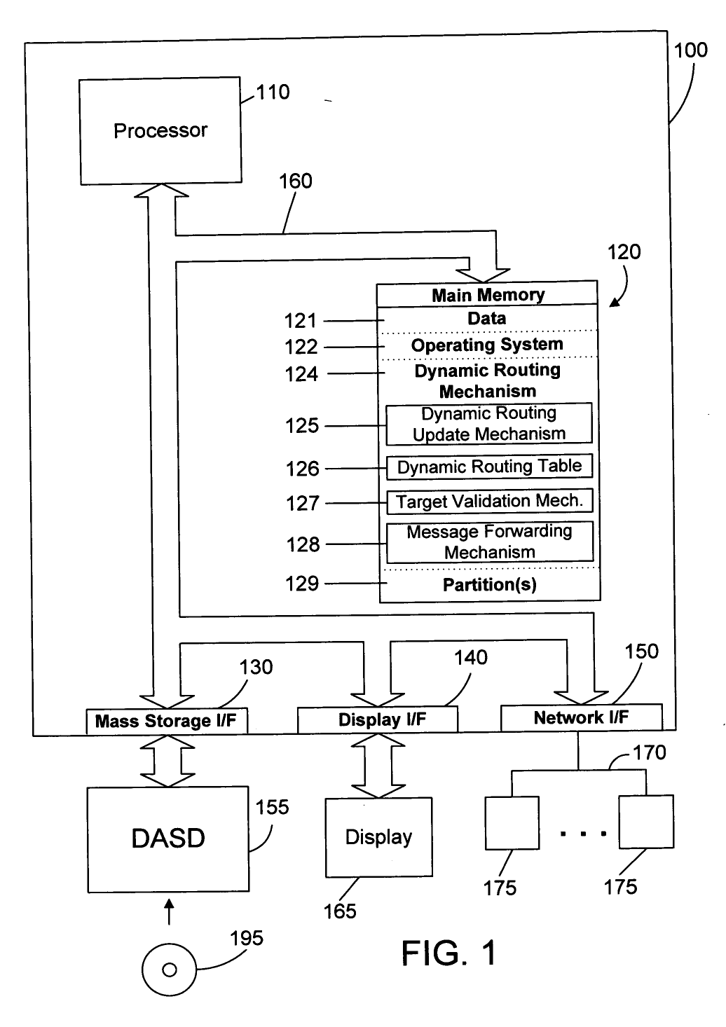

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a dynamic routing mechanism 124, and partitions 129. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Dynamic routing mechanism 124 preferably includes a dynamic routing update mechanism 125, a dynamic routing table 126, a target validation mechanism 127, and a message forwarding mechanism 128. Main memory 120 may also include one or more defined partitions 129. A partition is defined herein as any logical grouping of addresses. The dynamic routing update mechanism 125 is used to send a message to a different server when the server needs to update its dynamic routing table (as indicated by the different server routing a message to an incorrect target partition). In addition, the dynamic routing update mechanism 125 receives messages from other servers when the dynamic routing table 126 needs to be updated. The dynamic routing table 126 preferably contains address/partition tuples that correlate an address to a target partition that has responsibility for messages to that address. Each message preferably includes an address. The dynamic routing table 126 is used when a message is received to determine whether there is an entry that includes the address of the message, and if so, the partition responsible for the address is returned. The message may then be routed by the dynamic routing mechanism 124 to the target partition specified in the dynamic routing table 126.

The target validation mechanism 127 is used to validate a message that is received in the partition that includes the dynamic routing mechanism 124. The validation of the message simply means that the state data for the partition matches the required state to process the message. If the message is validated, the message may be processed by the partition that includes the dynamic routing mechanism 124. If the message is not validated, this means that stale data in a dynamic routing table in a different partition caused the message to be routed to the wrong place, to the old partition instead of the new, changed partition. As a result, the message forwarding mechanism 128 determines from the dynamic routing table 126 the correct target partition for the message, and forwards the message directly to the target partition.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, and graphical query and data mining interface 124 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

Referring now to FIG. 5, a clustered computer system 500 in accordance with the preferred embodiments includes multiple servers, shown in FIG. 5 as servers 520, 520A, . . . , 520N. Server 520 is assumed to function as a router for the cluster, and thus receives all messages from outside the cluster for all computer systems in the cluster. Server 520 thus includes the dynamic routing mechanism 124 shown in FIG. 1, with the corresponding items 125, 126, 127 and 128. Note that the dynamic routing table 126 is shown in more detail in FIG. 5 to include the address/partition tuples. Server 520 may also include one or more defined partitions 129. A second server 520A also includes a dynamic routing mechanism 124A with corresponding items 125A, 126A, 127A and 128A. The dynamic routing mechanism 124A uses the target validation mechanism 127A to validate messages it receives from the dynamic routing mechanism 124 in server 520A. If the message is not intended for the server 520A, the message forwarding mechanism 128A determines from the local dynamic routing table 126A the correct target partition, and forwards the message to the correct target partition. If forwarding the message is necessary, the dynamic routing update mechanism 125A sends a message to the dynamic routing update mechanism 125 in the dynamic routing mechanism 124 in server 520. This message informs the dynamic routing update mechanism 125 that the dynamic routing table 126 includes stale data, and therefore needs to be updated to include current data. Note that other partitions, such as partition N 520N in FIG. 5, will preferably include the same features shown in the dynamic routing mechanism 124A in the second server 520A.

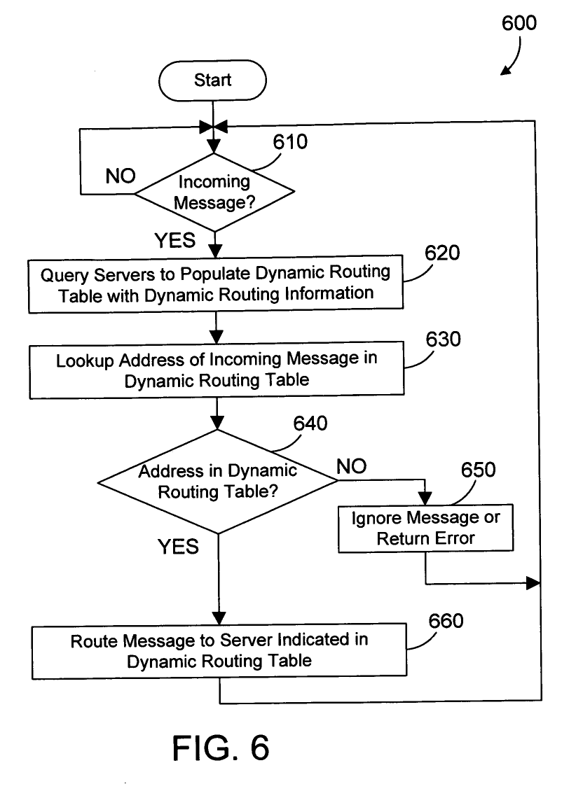

A method 600 in accordance with the preferred embodiments is shown in FIG. 6. Method 600 waits for an incoming message (step 610=NO). Once an incoming message is received (step 610=YES), the various different servers are queried to populate the dynamic routing table with dynamic routing information (step 620). As things evolve and resources are moved to different servers, the dynamic routing table in the dynamic routing mechanism 124 that serves as a router for the cluster could contain stale data, causing a message to be routed to an incorrect server. One way to overcome the problem of stale data in the dynamic routing table is to put sophisticated measures in place to assure that any change to any dynamic routing table is dynamically propagated to all dynamic routing tables in the cluster. This requirement, however, is very costly in performance and is difficult to implement. The preferred embodiments do not have the overhead of assuring no stale data, because any stale data can be quickly and dynamically corrected without a loss of any messages.

Once the dynamic routing tables in the cluster are configured in step 620, the address in the message is looked up in the dynamic routing table in the server that serves as a router for the cluster (step 630). If the address is not in the dynamic routing table (step 640=NO), the message is ignored or an error message is returned (step 650). If the address is in the dynamic routing table (step 640=YES), the message is routed to the server indicated in the dynamic routing table (step 660).

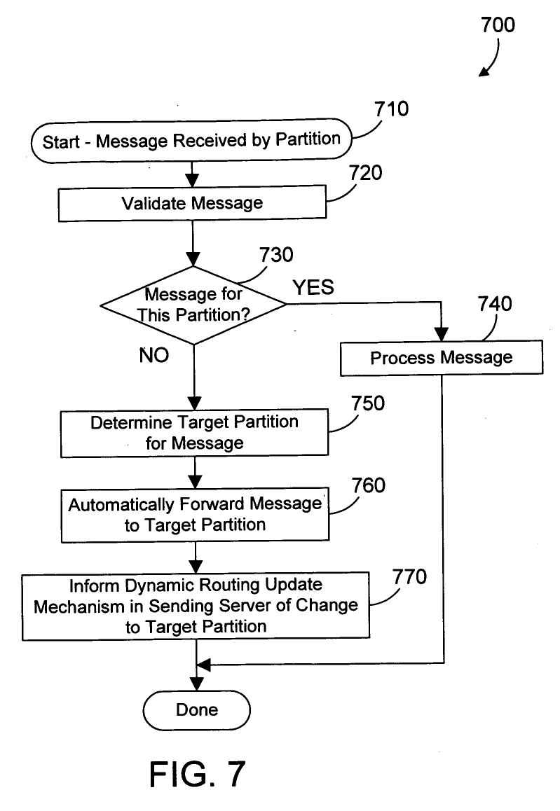

We now turn to FIG. 7 to determine what happens when a message is routed to an incorrect target partition due to stale data in the dynamic routing table of the server that serves as a router for the cluster. Method 700 begins when a message is received by a partition (step 710). The message is validated (step 720). The process of validating a message simply assures that the message is intended for the partition that received it. If the message is intended for this partition (step 730=YES), the message is processed (step 740). If the message is not for this partition (step 730=NO), method 700 determines the target partition for the message (step 750). This is preferably performed by the dynamic routing mechanism querying its own dynamic routing table. The message is then automatically forwarded to the correct target partition (step 760). The dynamic routing update mechanism in the server that sent the message is then informed of the change to the target partition (step 770). Method 700 allows stale data in a server's dynamic routing table due to the validation of the message in each partition and the ability to forward the message to the correct target partition, then automatically correct the stale data. Note that the stale data only affects one message, because once the stale data is discovered by the need for the original target partition to forward the message to the correct target partition, the dynamic routing table is then updated to reflect the change.

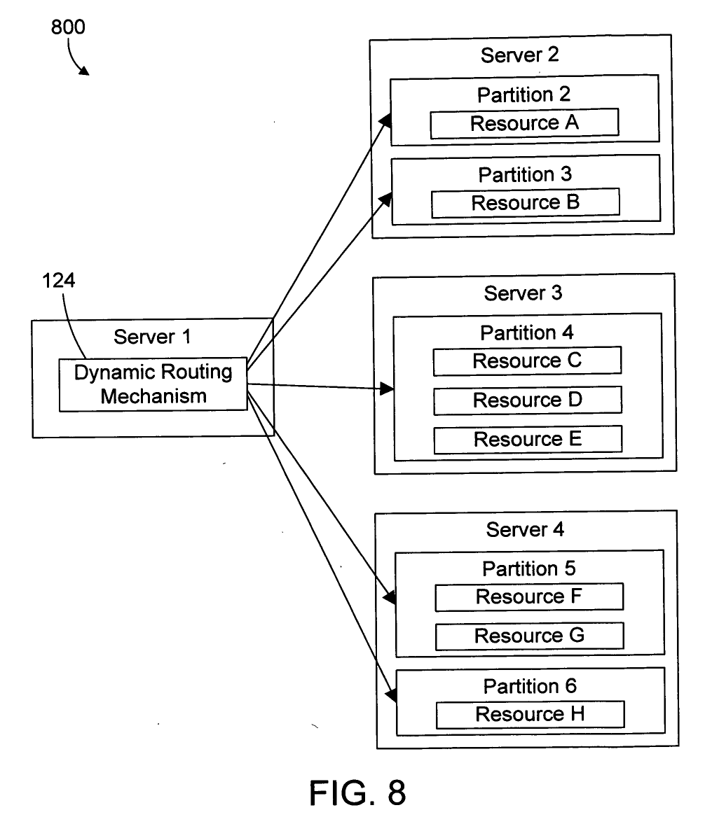

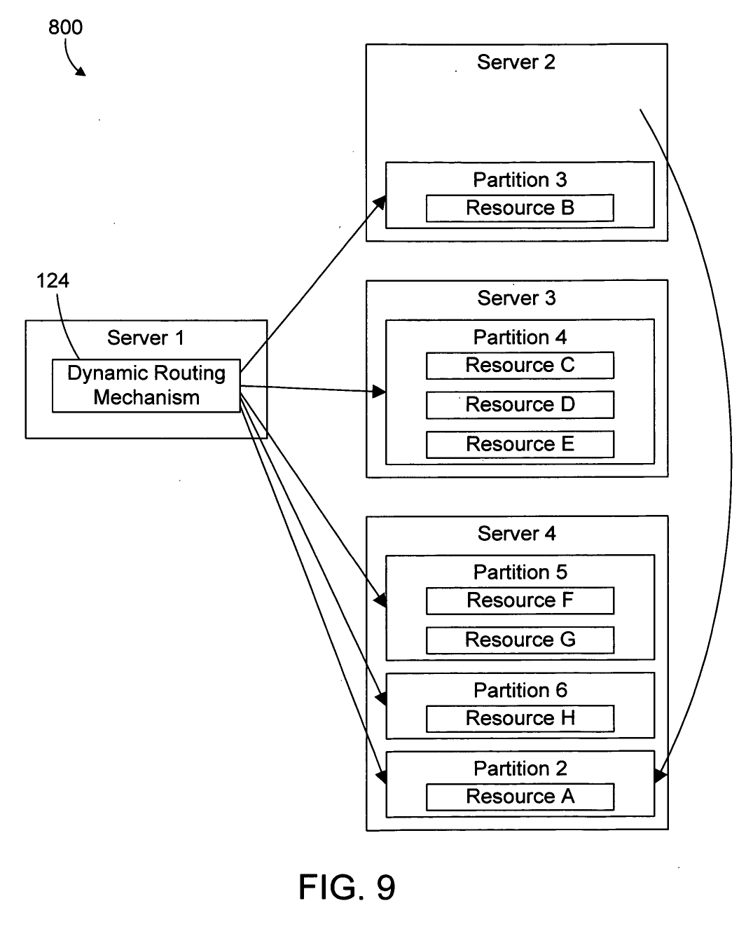

Referring to FIGS. 8 and 9, a simple example is shown to illustrate the concepts of the preferred embodiments. The computer system 800 in this specific example includes four server computer systems Server 1, Server 2, Server 3, and Server 4. Server 1 includes a dynamic routing mechanism 124 that serves as a router for the cluster by receiving all incoming messages for the cluster. Server 2 includes two partitions, Partition 2 that includes Resource A, and Partition 3 that includes Resource B. Server 3 includes a single partition, Partition 4 that includes Resources C, D and E. Server 4 includes two partitions, Partition 5 that includes Resources F and G, and Partition 6 that includes Resource H. We assume the configuration shown in FIG. 8 is the configuration just after the cluster powers-up.

Referring to FIG. 9, we now assume that Partition 2 and its corresponding Resource A in Server 2 is moved to Server 4, as shown by the curved arrow in FIG. 9. The reason for such a move could be many and varied. For example, Partition 2 may encounter a failure that requires it to shut down. A failover procedure could then move Partition 2 to Server 4. This is preferably done by first releasing Resource A from Partition 2, by deleting Partition 2 from Server 2, then by creating Partition 2 on Server 4, and allocating Resource A to the new Partition 2 on Server 4. In this manner, Resource A remains available notwithstanding the move of Partition 2. We assume that the dynamic routing table in Server 1 contains stale data, because it still points to Server 2 as the location of Partition 2. Note, however, that the mechanisms and methods of the preferred embodiments easily account for the stale data by performing target validation and peer forwarding.

Let's assume that just after Partition 2 is moved as shown in FIG. 9, a message comes in for Resource A in Partition 2. The dynamic routing mechanism 124 will consult its dynamic routing table, which we assume has stale data because the address for Resource A still indicates Server 2 as the appropriate location for Partition 2. The dynamic routing mechanism 124 thus routes the message to Server 2. The dynamic routing mechanism in Server 2 attempts to validate the message, and discovers it is not the proper server for the message. It then forwards the message directly to Server 4, and sends a message to the dynamic routing mechanism 124 that it needs to update its dynamic routing table to reflect that Server 4 is the destination for Partition 2 (which contains Resource A). The target validation and peer forwarding thus provide a simple and effective way to route messages without dropping any messages in a way that does not require absolute coherency of data in all routing tables in all partitions.

The preferred embodiments provide the ability to dynamically change resources between servers in a cluster in an efficient manner without having to keep all the routing tables perfectly in synchronization with each other. The issue of stale data is easily handled using target validation and peer forwarding as disclosed herein.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A computer system comprising:
at least one processor;
a memory coupled to the at least one processor;
a dynamic routing mechanism residing in the memory and executed by the at least one processor, the dynamic routing mechanism executing in a first partition, the dynamic routing mechanism comprising a dynamic routing table, the dynamic routing mechanism further comprising a dynamic routing update mechanism that receives an indication from a different partition that the dynamic routing table needs to be updated in response to the different partition forwarding a message to a server that is different than indicated in the dynamic routing table;
a validation mechanism residing in the memory and executed by the at least one processor, the validation mechanism determining whether a message should be processed by the first partition; and
a message forwarding mechanism residing in the memory and executed by the at least one processor, the message forwarding mechanism forwarding the message to a second partition when the validation mechanism indicates the message should not be processed by the first partition.

2. The computer system of claim 1 wherein the dynamic routing table comprises a plurality of address/server tuples, and wherein the message includes an address that allows locating the corresponding server in the dynamic routing table.

3. The computer system of claim 1 further comprising a routing update mechanism that sends an indication to a third partition that a dynamic routing table in the third partition needs to be updated in response to the message forwarding mechanism forwarding the message to the second partition.

4. A networked computer system comprising:
(A) a first computer system comprising:
a dynamic routing mechanism that includes a dynamic routing table, the dynamic routing mechanism further including a dynamic routing update mechanism that receives an indication from a second computer system that the dynamic routing table needs to be updated;
(B) the second computer system comprising:
a validation mechanism that determines whether a message should be processed by the second computer system;
a message forwarding mechanism that forwards the message to a third computer system if the validation mechanism determines that the message should be processed by the third computer system; and
in response to the message forwarding mechanism forwarding the message to the third computer system, a routing update mechanism sends an indication to the dynamic routing update mechanism in the first computer system that the dynamic routing table needs to be updated.

5. The apparatus of claim 4 wherein the dynamic routing table comprises a plurality of address/server tuples, and wherein the message includes an address that allows locating the corresponding server in the dynamic routing table.

6. A computer-implemented method for routing a message to a plurality of partitions in a computer cluster, the method comprising the steps of:
receiving a message;
determining from a dynamic routing table a target partition for the message;
routing the message to the target partition;
validating the message to determine whether the message should be processed by the target partition;
if the message should not be processed by the target partition, forwarding the message to a different partition; and
in response to the forwarding of the message to the different partition, sending an indication that the dynamic routing table needs to be updated.

7. The method of claim 6 wherein the step of forwarding the message to a different partition comprises the step of determining that the different partition should process the message.

8. The method of claim 6 wherein the dynamic routing table comprises a plurality of address/partition tuples, and wherein the message includes an address that allows locating the corresponding partition in the dynamic routing table.

9. The method of claim 6 wherein the first partition resides on a first computer system and the second partition resides on a second computer system coupled via network connection to the first computer system.

10. The method of claim 9 wherein the third partition resides in one of the first and second computer systems.

11. The method of claim 9 wherein the third partition resides in a third computer system coupled via network connection to the first and second computer systems.

12. A program product comprising:
(A) a dynamic routing mechanism executing in a current partition, the dynamic routing mechanism comprising:
a dynamic routing table;
a dynamic routing update mechanism that receives an indication from a different partition that the dynamic routing table needs to be updated in response to the different partition forwarding a message to a partition that is different than indicated in the dynamic routing table;
a validation mechanism that determines whether a message should be processed by the current partition;
a message forwarding mechanism that forwards the message to a third partition if the validation mechanism determines that the message should be processed by the third partition; and
(B) computer-readable signal bearing media bearing the dynamic routing mechanism.

13. The program product of claim 12 wherein the computer-readable signal bearing media comprises recordable media.

14. The program product of claim 12 wherein the computer-readable signal bearing media comprises transmission media.

15. The program product of claim 12 wherein the dynamic routing table comprises a plurality of address/server tuples, and wherein the message includes an address that allows locating the corresponding server in the dynamic routing table.

16. The program product of claim 12 further comprising a routing update mechanism that sends an indication to a third computer system that a dynamic routing table in the third computer system needs to be updated in response to the message forwarding mechanism forwarding the message to the second computer system.
